(19) United States
(12) Patent Application Publication
(10) Pub. No.: US 2007/0009804 A1
(43) Pub. Date: Jan. 11, 2007

(54) Heteroatomic polymers as safer electrolytes for magnesium batteries

(76) Inventors: Brian Gilbert Dixon, Sandwich, MA (US); Robert Scott Morris, Fairhaven, MA (US); Brett Gall, Sandwich, MA (US)

Correspondence Address: Phoenix Innovation, Inc., 20 Patterson Brook Road, Box 550, West Wareham, MA, 02576, US

(21) Appl. No.: 11/178,777

(22) Filed: Jul. 11, 2005

(51) Int. Cl. H01M 10/40; H01G 9/02

(52) U.S. Cl. 429/306; 252/62.2

(57) ABSTRACT

An electrolyte is described that represents a new composition of matter. This electrolyte contains alternating electronegative group III-VI elements connected with hydrocarbon or fluorocarbon linkages to form a polyalkyl or polyfluoroalkyl heteroatomic that is used in combination with magnesium ions. These materials can also be combined with magnesium salts or organometallic (metalloorganic) compounds to form a novel electrolyte for use in electrochemical systems, such as batteries. The new electrolytes exhibit magnesium cation diffusion and transport numbers that are equivalent to standard battery electrolytes, such as carbonates. The new electrolytes are nonflammable which represents a substantial advance in the state of the art, especially as it pertains to safety.

### SUMMARY OF THE INVENTION

### Description of the Art

Magnesium batteries have substantial inherent promise as rechargeable systems for many applications, including the electric car and portable electronics and tools. Compared to lithium batteries they are inherently safer and more dependable. However, in order to achieve success the battery components must be made safer yet, and this especially includes the electrolyte. State of the art electrolytes, such as carbonates or polyethylene oxides, are flammable and pose substantial fire risks.

One of the primary objectives of recent battery research has been to develop polymeric electrolyte materials possessing acceptable ionic conductivities as replacements for liquid carbonates, the latter being the industry standard for lithium systems. Historically, this research has dealt with a number of variations of the early poly(ethyleneoxide) [PEO] work of Armand (Armand, M. B.; Chabango, J. M. and Duclot, M., 2nd Int. Conf on Solid Electrolytes, Extended Abstracts 20-22, St. Andrews, (1978)) in an attempt to find a polymer that could support good ambient temperature ionic conductivity. Early work involved making PEO more amorphous by including flexible groups in the polymer. Two representative examples in this approach include poly[bis-(methoxyethoxyethoxide)]phosphazene MEEP and polyethoxy(ethoxy-ethoxy-vinyl)ether PEEVE (Blonsky; P. M., Shriver; D. R.; Austin; P. and Allcock; J., J. Am. Chem. Soc., 106, 6854, (1984)). More recently, the combination of thermoplastic polymers with liquid electrolytes (i.e. ethylene carbonate, propylene carbonate) resulted in a “gelled” electrolyte and represented an attempt to tap the better properties of solvents in a solid electrolyte (Abraham, K. and Alamgir, G. J. Power Sources, 43-44, 195-208, (1993)). Although the ionic conductivities of the gelled polymer electrolytes have been among the highest measured in a room temperature polymer electrolyte, problems persist, because of the dubious mechanical and chemical properties and flammability of these materials (Dautenzenberg, G.; et al, Chem. Mater, 6, 538-42, (1994)). For magnesium systems, besides various carbonate based electrolytes, polyethylene oxides, polyacrylates, polyacrylonitriles, and Grignard-PEO based formulations have been explored with modest success (Yoshimoto, N.; et al, Electrochim. Acta 50 3866 (2005)).

All of these approaches have focused on using ether oxygens in the “solvent” (either a liquid or a polymer) to solubilize and coordinate magnesium salt cations that carry the ionic charge through the electrolyte. In the case of the liquid electrolyte, the solvent is carried along with the cation through the bulk of the electrolyte. In the case of the true “solventless” solid polymer electrolyte, the polymer is stationary and the cations are moved along the chain from one ether oxygen (active site) to the next by the segmental motion of the polymer. This is one reason why it is thought that amorphous polymers are superior to crystalline polymers in promoting ionic conduction. The amorphous polymer model of cations moving along the chain is an oversimplification. Gray gives a more graphic description of the process that takes into account ion-ion association, and inter and intrachain ion hopping (Gray, F. M., “Polymer Electrolytes”, RSC Monograph, The Royal Society of Chemistry, Cambridge, UK, (1997)). However, as Gray points out, the exact mechanism of ion conduction in a solventless polymer is as yet unknown.

Recent events have highlighted the importance of safety for high energy density batteries, such as lithium and magnesium rechargeable systems. To date such batteries involve the use of flammable electrolytes, such as carbonate mixtures, that have resulted in numerous fire and explosion incidents, as well as many battery recalls in the case of lithium.

The instant invention is designed to combine high ionic conductivity with nonflammability in a single electrolyte substantially superior to state of the art magnesium battery electrolytes.

### OBJECTS OF THE INVENTION

It is an object of the invention to provide the novel formulations I and II and a process of preparing the same.

It is another object of the invention to provide a novel process for the preparation of phosphite, phosphonate and phosphate electrolytes using compounds of the formulas I, II and III, and various magnesium salts.

It is still another object of the invention to describe novel uses of these new compounds.

These and other objects and advantages of the invention will become obvious from the following detailed description.

### SUMMARY OF THE INVENTION

The present invention constitutes a new family of safe magnesium battery electrolytes that can be used for a variety of applications. The combination of inorganic elements with organic carbon segments to form a thermodynamically stable material is novel and heretofore unprecedented. The novelty of the proposed material lies in its unique combination of soft acid, strong acid elements linked together with organic spacers to provide a new material with an amorphous character and physical and chemical properties distinct from its counterparts, such as polyethyleneoxide or polyethyleneimine. Particularly important from the standpoint of safety is the incorporation of covalently bound phosphorous moieties which impart the safety inducing property of nonflammability to the whole. This covalent incorporation is also important from the standpoint of ionic conductivity and overall battery performance.

One general embodiment of the present invention can be summarized by Formula I, shown by the following drawing:

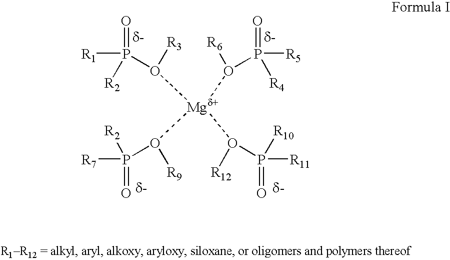

Where R₁-R₁₂ are alkyl, aryl, alkoxy or aryloxy groups, including monomeric, oligomeric and polymeric molecules derived therefrom, as well as siloxane derivatives. Note too that the following representation Formula Ia is an obvious variation of Formula I:

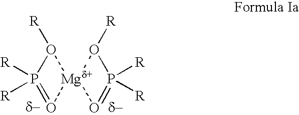

Another embodiment of the present invention is shown by Formula II:

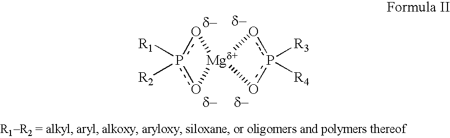

In this instance the magnesium cation is ionically bound to the phosphorus ester groupings.

The phosphorus can be present in either the ⁺3 or ⁺5 oxidation state, especially 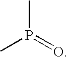
The magnesium ion, with a partial positive charge, can be either an inherent part of the phosphorous-based entity, or incorporated as in a salt form, such as magnesium triflate or tetrafluoroborate, or an organometallic (metaloorganic), such as a Grignard. The various elements are connected using hydrocarbon or fluorocarbon spacers, an example of which is the —CH₂—CH₂— ethylene linkage, and the entire molecule forms a heteroatomic entity. If polymeric or oligomeric it can be of varying molecular weight ranging from 400 to 1,000,000 MW. The array of ethylene spacer and element groups, i.e. 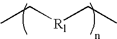
can vary from an even distribution of each ethylene spacer and element group to an uneven distribution. Besides using ethylene carbon spacers in this polymer, the elements can also be connected using propylene, butylenes or phenylene spacers. In addition, combinations of ethylene and propylene, phenylene or butylene spacers can be used to connect the heteroatomic elements in the polymer. The spacers can also have alternating odd and even numbers of —CH₂— or —CF₂— links. This will ensure greater amorphous character in the polymer. Fluorocarbon analogs to these hydrocarbon groups can also be employed together with hydrocarbon groups or in direct replacement for hydrocarbon groups. In addition to using the select elements directly, in certain circumstances some of these select elements can contain organic substitutents that modify the characteristics of the polymer. For example: in the case of P or N, an organic substitutent can be added prior to polymerizing the monomers used to prepare the polymer 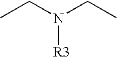
In this instance, the R3 group can be an alkyl or aryl group, e.g. methyl, nitrophenyl or aminophenyl group. The same circumstances apply to the trivalent element phosphorus. In this latter instance, the P atom could be connected to ethylene groups via an oxygen atom, or could be bonded directly to the carbon of the ethylene group or similar alkyl or fluoroalkyl substituent or spacer. Here again the species with phosphorus in the +3 and +5 oxidation state are viable.

In another embodiment of the basic concept, of the essentials of the invention could be combined according to Formula III:

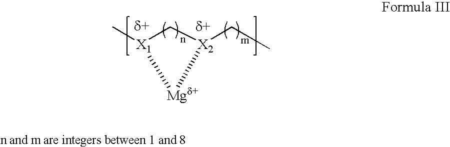

Where X₁ is an element chosen from the group N, B or S and R₂ is an element chosen from the group: O or P, including P in the form of phosphine, phosphonate, and phosphate moieties. In addition, R₁ can be O while R₂ is P in this compound. In all cases, phosphorus can be in the ⁺3 or ⁺5 oxidation state. Once again, these elements are connected using ethylene, propylene, butylenes or phenylene spacers and the entire molecule can form a heteroatomic polymer. The polymer can be of varying molecular weight ranging from 400 to 1,000,000 MW. The array of alkylene element groups, i.e. 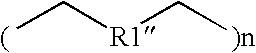
can vary from an even distribution of each distribution of ethylene element group to an uneven distribution in ratios of 2 R₁ groups to one R₂ group to 5 R₁ groups to 1 R₂ group. Besides using ethylene carbon spacers in this polymer, the elements can also be connected using propylene, phenylene and butylene spacers. In addition, combinations of ethylene and propylene and phenylene or butylene spacers can be used to connect the heteroatomic elements in the polymer. These alkyl or fluoroalkyl spacers could be branched with alkyl or fluoroalkyl side chains emanating from the backbone of the spacer group. In addition to using the select unsubstituted elements directly, in certain circumstances some select elements can contain substituents that modify their chemical characteristics and subsequently those of the polymer. For example: in the case of P or N, an organic substitutent can be added prior to polymerizing the monomers used to prepare the polymer 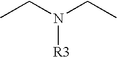
In this instance, the R₃ group can be a aromatic or aliphatic in nature, e.g. methyl, phenyl, nitrophenyl or aminophenyl group. The same circumstances apply to the pentavalent form of phosphorus.

### EXAMPLES OF THE DESCRIBED INVENTION

The novel process of the invention for the preparation of a compound of the formulas I, II and III can involve one of a number of different synthetic routes. In the following examples, there are described several preferred embodiments to illustrate the invention. However, it should be understood that the invention is not intended to be limited to the specific embodiments.

### Example 1

A transesterification reaction to make the phosphonate diester product can be run under stoichiometric conditions, with dimethylmethylphosphonate and diethyleneglycol, and 10 mole % magnesium methoxide. The reaction is run under reflux conditions for 8-24 hrs, and under an inert atmosphere, for example nitrogen. The product can be purified using liquid column chromatography.

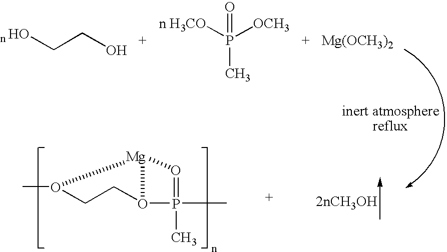

A similar procedure can be used to prepare the corresponding amino derivative:

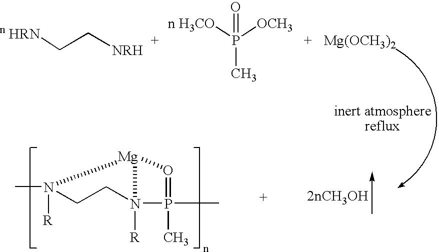

R here is defined as described above for R₁-R₁₂. A similar reaction can be run to synthesize the phosphate triester by substituting stoichiometric amounts of trimethyl phosphate for dimethylmethylphosphonate as shown generically below. This represents a crosslinked system.

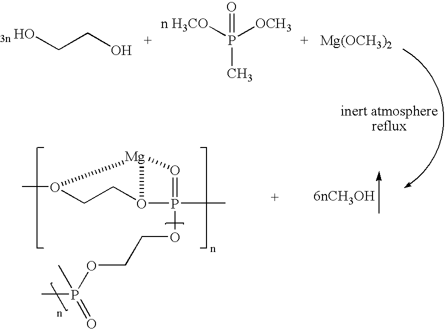

### Example 2

A similar procedure to that of example 1 can be used to prepare the corresponding amino derivative:

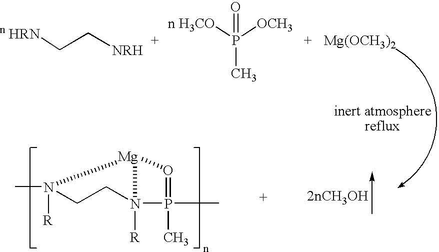

In this case the triester reaction run using trimethyl phosphate in place of dimethylmethylphosphonate can also be carried out.

### Example 3

An example of a synthesis of formula II materials is the sequential reaction of dimethyloctyl phosphonate with bromotrimethylsilane followed hydrolytic desilylation with magnesium hydroxides:

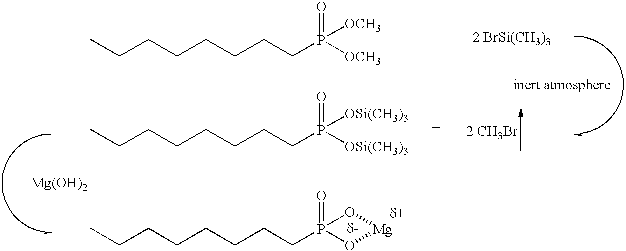

### Example 4

Phosphine examples can be readily synthesized using acid chloride chemistry as follows. Chlorodiphenyl phosphine can be reacted with a tetraethylene glycol in the presence of an acid scavenger to yield a phosphorus-based electrolyte with phosphorus in a +3 oxidation state.

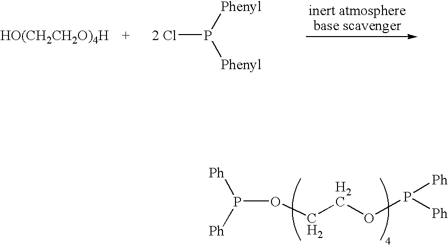

A similar reaction can be run using a dichlorophosphine reactant to make polymeric products:

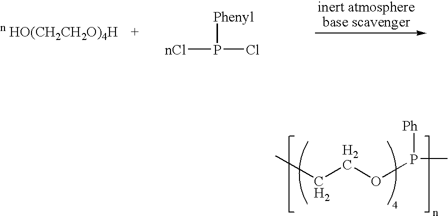

### Example 5

Arbuzov reactions are a classical way to synthesize potentially useful phosphonate or phosphate electrolytes, for example:

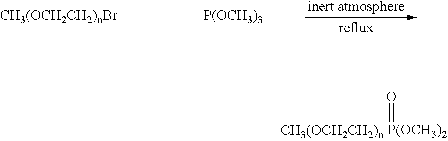

Multifunctional halide reactants can also be used in the Arbuzov reaction at the appropriate adjusted stoichiometries.

### Example 6

As an alternative, compounds of the general formula I including siloxane moieties can be prepared according to the following reaction scheme:

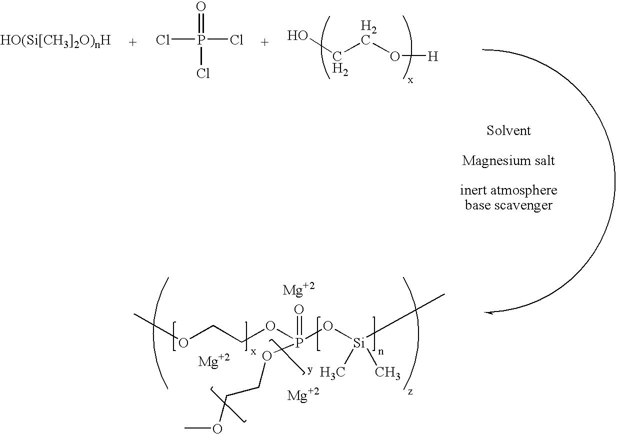

In this instance, stochiometric quantities of a hydroxydimethylsiloxane is combined with phosphorus oxytrichloride and ethylene glycol in toluene, and a magnesium compound, and the mixture is acidified using Nafion 117 pellets as an acid catalyst. The solution mixture is then heated to 60° C. and refluxed under dry argon gas for 10 hours to effect the polymerization of the product. At the end of this period, the methylene chloride is removed using a rotary evaporator and the polymeric product is harvested, and purified using multiple extractions with drymethylene chloride. The final product is dried overnight in a vacuum oven at 40° C.

### Example 7

Using these polymers and salts of magnesium, one can easily prepare solid polymer electrolytes for use in magnesium batteries. In this manner, we have prepared a solid polymer electrolyte composed of a P, O polymer and magnesium perchlorate (LiClO₄) by dissolving the Mg(ClO₄)₂ in anhydrous ethanol and then combining this solution with a 400 MW P, O polymer in an 8:1 Mg⁺²:O, P ratio. This resulted in a viscous, clear liquid. An alternative approach is to dissolve the lithium salt and the polymer in dry methanol and then remove the methanol using a vacuum apparatus. The product is a clear film. Other magnesium salts such as magnesium triflate, tetrafluoroborate, magnesium bisfluoroethanesulfonylimide (BETI) or magnesium bisperfluoromethanesulfonylimide can also be used in place of magnesium perchlorate.

### Example 8

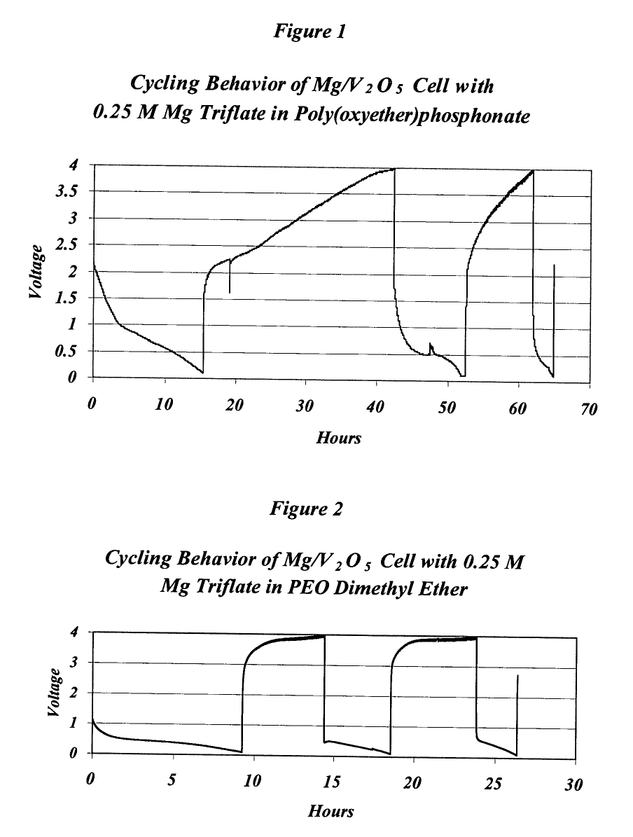

To demonstrate the utility of a phosphonate-magnesium electrolyte, FIGS. 1 and 2 show the cycling behavior of two Mg/V₂O₅ (magnesium metal anode, vanadium pentoxide cathode) cells using the same two polymer electrolyte systems, 0.25 M Mg triflate in a typical PEGphosphonate (FIG. 1) and 0.25 M MgTf in PEG dimethyl ether (FIG. 2). The cell using the PEGphosphonate delivered a higher discharge voltage than the standard PEG based electrolyte. In addition, during charge the cell containing PEG showed much greater polarization upon recharge than the PEGphosphonate cell. This is evidenced by the cell polarizing to >2.5V upon recharge in the PEG case versus 1.4-1.5V polarization upon recharge in the case of our PEGphosphonate electrolyte. This suggests more facile Mg plating on the anode in the presence of the phosphonate-based electrolyte.

What is claimed is:

1. A formulation composed of a magnesium salt or organometallic (metalloorganic) compound combined with a monomer, oligomer or polymer with saturated alkyl or fluororalkyl carbon links that connect alternating nitrogen, sulfur or oxygen atoms or connect either an oxygen or nitrogen or sulfur atom through saturated alkyl or fluoroalkyl carbon spacers to oxy-phosphorus (valence III or V) group or an oxy-silicon group oxyboron or oxyaluminum group or combination of these groups.

2. An monomer, oligomer or polymer as claimed in claim 1 of molecular weight of 200 to 1 million wherein the polymer is comprised of alternating oxygen and nitrogen atoms and the links are saturated alkyl or fluoroalkyl carbon spacers.

3. A monomer, oligomer or polymer as claimed in claim 1 of molecular weight of 200 to 1 million wherein the polymer is comprised of alternating oxygen and sulfur atoms and the links are saturated alkyl or fluoroalkyl carbon spacers.

4. A monomer, oligomer or polymer as claimed in claim 1 of molecular weight of 200 to 1 million wherein the polymer is comprised of alternating sulfur and nitrogen atoms and the links are saturated alkyl or fluoroalkyl carbon spacers.

5. A monomer, oligomer or polymer as claimed in claim 1 of molecular weight of 200 to 1 million wherein the polymer is comprised of alternating oxygen atoms and oxy-phosphorus groups and the links are saturated alkyl or fluoroalkyl carbon spacers.

6. A monomer, oligomer or polymer as claimed in claim 1 of molecular weight of 200 to 1 million wherein the polymer is comprised of alternating oxygen atoms and oxy-silicon groups and the links are saturated alkyl or fluoroalkyl carbon spacers.

7. A monomer, oligomer or polymer as claimed in claim 1 of molecular weight of 200 to 1 million wherein the polymer is comprised of alternating nitrogen atoms and oxy-phosphorus groups and the links are saturated alkyl or fluoroalkyl carbon spacers.

8. A monomer, oligomer or polymer as claimed in claims 2 and 7 wherein the nitrogen atoms are fully or partially substituted with alkyl or fluoroalkyl tertiary substituents.

9. A monomer, oligomer or polymer as claimed in claims 2 and 7 wherein the phosphorus atoms are fully or partially substituted with alkyl or fluoroalkyl tertiary substituents.

10. A monomer, oligomer or polymer as claimed in claims 2 and 7 wherein the nitrogen and phosphorus atoms are fully or partially substituted with alkyl or fluoroalkyl substituents.

11. A monomer, oligomer or polymer as in claim 1 wherein the spacer links can be two to four carbons in length and can contain alkyl or fluoroalkyl branches.

12. A monomer, oligomer or polymer as in claim 1 wherein the spacer links can have side chain substitutents.

13. A monomer, oligomer or polymer electrolyte comprising: (i) at least one monomer, oligomer or polymer as in claim 1 and (ii) at least one electrolyte salt.

14. The monomer, oligomer or polymer electrolyte as claimed in claim 7 or 8, and 13 wherein the electrolyte salt is selected from an alkali metal salt, an alkaline earth salt, a quaternary ammonium salt and a quaternary phosphonium salt or a sulfonylimide or sulfonylmethide in a range of weight ratios to form a polymer electrolyte.

15. The monomer, oligomer or polymer electrolyte as claimed in claim 7 or 8, and 13 that includes an organometallic or metallorganic alkaline earth compound.

16. A polymer electrolyte as in claim 14 that can be cast as a film.
